(19) United States
(12) Patent Application Publication
(10) Pub. No.: US 2014/0278494 A1
(43) Pub. Date: Sep. 18, 2014

(54) SYSTEMS AND METHODS FOR HEALTH CARE ACCOUNT PROCESSING

(71) Applicant: Solarte Health, Inc., Minneapolis, MN (US)

(72) Inventors: Merlin Brown, Minneapolis, MN (US); Arturo Solarte, Minneapolis, MN (US); Michael McDonald, Brooklyn Park, MN (US); Ross Ronnenberg, Plymouth, MN (US); Kathryn Miller Clayton, Savage, MN (US)

(73) Assignee: Solarte Health, Inc., Minneapolis, MN (US)

(21) Appl. No.: 14/209,635

(22) Filed: Mar. 13, 2014

Related U.S. Application Data
(60) Provisional application No. 61/782,242, filed on Mar. 14, 2013.

(51) Int. Cl. G06Q 50/22; G06Q 20/10

(52) U.S. Cl. CPC G06Q 50/22; G06Q 20/10
USPC 705/2

(57) ABSTRACT

Systems and methods are described herein to provide a health care account processing solution that can (1) provide financial security when a participant experiences unexpected major medical expenses the participant may not otherwise be able to afford, (2) provide control of health care decisions to participants and providers, (3) reduce overhead and structural costs required to administer traditional health insurance plans, (4) reduce over-utilization and under-utilization of health care through a participant-controlled health care spending account that can be coupled with a health and wellness program (e.g., a rewards-based wellness program), and (5) encourage provider competition through the use of cash based, point-of-sale payments and transparent pricing. The systems and methods discussed herein describe, among other things, computer-implemented, rules-based systems for managing the health care accounting solution introduced above. In some examples, the rules-based systems are applicable for processing other types of transactions than health care-related transactions.

### CLAIM OF PRIORITY

This application claims the benefit of priority under 35 U.S.C. §119(e) of U.S. Provisional Patent Application Ser. No. 61/782,242, filed on Mar. 14, 2013, which is herein incorporated by reference in its entirety.

### BACKGROUND

Health insurance generally involves individuals or groups with pooled resources to insure against a risk of medical expenses incurred by one or more individual participants under a health insurance plan. Insurers can consider an overall health risk and related health care system expenses for an individual or group, and can provide insurance products accordingly. Generally, health insurance is provided to individuals under an insurance agreement contract that defines the terms of coverage. In many cases, benefits are received based on the type or source of care received.

Health insurance is offered by, among others, government agencies, private businesses, and non-profit entities. In order to be covered by a health insurance plan, an individual (and sometimes the individual's employer) generally is required to pay the insurer in the form of a premium (e.g., monthly, annually, etc.). Some health insurance plans operate under a deductible whereby the insured is required to contribute a particular amount of money toward their care before the health insurer pays its portion. Deductibles can apply to, among other things, clinic visits, hospitalizations, or prescription drugs. Some health insurance plans offer a coinsurance benefit that can include requiring the insured to contribute a fixed percentage of a cost of care. In some examples, deductibles and coinsurance apply to the same health insurance plan.

Health insurance plans generally include some exclusions or limitations, such as including prohibitions on some procedures or services. The insured may be required to pay out-of-pocket for care that is excluded or otherwise limited. Some health care plans are provided to particular groups of individuals. For example, Medicaid (a state-sponsored health insurer) provides health care for low-income children and families, and for people with disabilities. Medicare is a government health insurance plan for people age 65 or older, people under 65 with certain disabilities, and people with end-stage renal disease.

### OVERVIEW

Systems and methods are described herein to provide a health care account processing solution that can (1) provide financial security when a participant experiences unexpected major medical expenses the participant may not otherwise be able to afford, (2) provide control of health care decisions to participants and providers, (3) reduce overhead and structural costs required to administer traditional health insurance plans, (4) reduce over-utilization and under-utilization of health care through a participant-controlled health care spending account that can be coupled with a health and wellness program (e.g., a rewards-based wellness program), and (5) encourage provider competition through the use of cash based, point-of-sale payments and transparent pricing. The systems and methods discussed herein describe, among other things, computer-implemented, rules-based systems for managing the health care accounting solution introduced above. In some examples, the rules-based systems are applicable for processing other types of transactions than health care-related transactions.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an interaction scheme between a participant account and a third party.

FIG. 2 is a block diagram illustrating generally example transaction flows between a third party services layer and a product integration platform.

FIG. 3 is a block diagram illustrating generally example transaction flows between a participant account hub and other aspects of the system.

FIG. 4 is a block diagram illustrating generally example transaction flows in a contribution portal.

FIG. 5 is a block diagram illustrating generally an example of a plan control hub.

FIG. 6 is a block diagram illustrating generally an example that includes transaction processing rules.

FIG. 7 is a block diagram illustrating generally an example that includes debit transaction processing rules.

FIG. 8 is a block diagram illustrating generally an example that includes credit transaction processing rules.

FIG. 9 is a table illustrating generally several examples of account transactions.

FIG. 10 is a block diagram illustrating generally an example that includes contribution processing rules.

FIG. 11 is a table illustrating generally several examples of account contribution transactions.

### DETAILED DESCRIPTION

Systems and methods described herein provide, among other things, a vehicle that protects participants from financial risks associated with major medical expenses, provides consumer-oriented conveniences and efficiencies, such as a credit card-based payment system, and encourages free market principles of price transparency and competition. In an example, the systems and methods can be used to administer a health insurance plan, such as by providing a notional participant account that is accessible by the participant using, among other things, a credit card-like system, such as using existing credit card processing framework to process payments from the notional participant account. The processing of payments can include debiting or crediting an account balance, or accessing insurer-provided funds or resources. In an example, the systems and methods are used to receive transaction requests to the notional participant account, and automatically select from one or more associated accounts to satisfy the transaction debit or credit. For example, in response to initialization of a debit transaction, the systems and methods can allocate a portion of funds from at least first and second accounts to satisfy the debit. In an example, the first account includes a cash-like account, and the second account includes one or more of a coinsurance or line-of-credit account. In some examples, transactions with one or more of the accounts count toward a participant deductible.

In an example, a Health Care Services Account (HCSA) is provided. The HCSA is conceptually a bank account with rules that govern transactions into (e.g., deposits or credits) and out of (e.g., withdrawals or debits) the account. In an example, and as further described below, the HCSA provides advantages that include, but are not limited to, cash payments to providers (i.e., without medical billing codes and without claims), provider price transparency, integrated health and wellness incentives with participant advocacy tools, and diminishing participant premiums, such as when the HCSA balance accrues over time.

In an example, a cash-based payment system is provided that participants can use for many health care products or services. Providers (e.g., caregivers, hospitals, vendors, retailers, and the like) can be paid at a point of sale, when a service is performed, or when care is given, such as without submitting detailed claims and without waiting for subsequent reimbursement from an insurer or other entity. In an example, payment is provided from the participant to a provider using a proprietary Benefits Card, which can function similarly to a consumer credit card from the provider's perspective. That is, the card itself can be a similar size and shape, and can include, among other things, participant identification information, including information about the participant or the participant's HCSA stored on or within the card, such as magnetically or using an RF-enabled chip.

In some examples, transactions performed using the Benefits Card are processed using existing bank card processing or payment networks (e.g., networks provided by Visa, MasterCard, etc.). Because payment is made by the Benefits Card (and a participant-specific HCSA linked to the Benefits Card), a caregiver or vendor can immediately collect payment just as they would from a traditional credit card transaction. A provider's billing and bad debt collection costs are eliminated, there is no need for claims to be coded and processed, and the traditional insurance overhead requirements related to approvals, quality, and managed care are eliminated.

In an example, the Benefits Card is linked to the participant HCSA, and the HCSA includes multiple (notional) accounts. For example, a first account can be a cash-like account (e.g., like a savings or checking account accessible via a traditional debit card), and a second account can be another type of account, such as a line-of-credit account, or other account provided under the participant's health insurance plan. In an example, when a participant pays a provider using the Benefits Card, funds are initially withdrawn from the first, cash-like account. If the balance available in the first, cash-like account is exceeded by the transaction, other accounts (e.g., the line-of-credit account) can be used to pay the remaining balance due.

In an example, the HCSA is a virtual account that can be owned or maintained by an insurer or other administering entity. The HCSA can be a tax-qualified account that is accessible to participants through use of the Benefits Card, and can be used to pay for participant health care costs. In an example, some health care costs are not eligible for payment by the HCSA, such as determined by local or federal law governing the tax-qualified account.

In an example, the HCSA is used according to an Integration Platform, described below and shown in the figures below, that enables participant-level account and transaction settlement between the insurer and the participant's HCSA. That is, the Integration Platform describes or defines some of the transaction rules governing use of the HCSA by a participant.

In an example, the HCSA can be funded on a pre-tax basis, such as by an employer. The HCSA can include an account, or portion of an account, that provides “first dollar” coverage for many health care expenditures, such as up to an available participant balance. In an example, the HCSA includes a “back end” deductible whereby participant spending can be subject to a deductible before co-insurance or other insurance benefits take effect. The HCSA can include a line-of-credit to cover payments for health care products or services that exceed an available participant balance. In an example, the line-of-credit can be paid off by the participant using, for example, payments made through future premium contributions, or payments made directly into the line of credit account by the participant (e.g., using pre-tax or post-tax dollars, as available). In an example, the HCSA includes a balance that can roll over from plan term to plan term if not used by the end of a plan term (e.g., the balance can roll over each year when the plan term is one year).

In an example, if a participant grows a Health Care Services Account balance, such as by participant or employer contributions to the account, the accumulated balance can enable pricing strategies and benefits that provide, for example, diminishing premiums for either the employer or employee. That is, in some examples, a participant premium, such as paid by the participant or the participant's employer, can optionally be reduced as the participant's HCSA balance increases. In some examples, diminishing premiums can be applied on a group-wide basis. Diminishing premiums, such as coupled with Health and Wellness Program incentives, can provide discounts for health care costs to participants who are health or who choose to be cost conscious with their use of health care benefits or their selection of health care providers or services.

In an example, access to cash-based provider prices (e.g., not limited to insurance plan contract rates) can be provided to help consumers make cost-effective health care choices.

In an example, an integrated health and wellness program can reward participants for satisfactory outcomes in the form of incentive contributions to their Health Care Services Account. In an example, the incentive contributions can be applied to one or more of the cash-like account, line-of-credit account, or a rewards-based account, as can be available under the HCSA.

Referring now to FIG. 1, an integration platform is provided to interface with, e.g., third party banking services. FIG. 1 presents a top level view of several platform support components. For example, third party banking services can include a bank card processing platform, payment networks, and merchant point-of-sale systems. The integration platform can be communicatively coupled with the bank card processing platform, such as to exchange information about HCSA transactions. In an example, the participant account hub includes systems and methods for allocating funds and managing HCSA balance(s). The participant account hub can be linked to a plan control hub, such as can provide information on one or more supported plans, and the participant account hub can be linked to a contribution portal, such as can receive allocations from, among other sources, premiums, payments, or other allowances.

FIG. 2 is a block diagram illustrating generally example transaction flows between a third party services layer and a product integration platform. In an example, the platform leverages third party banking services for processing payments (e.g., cash payments, or cash-like payments) to health care providers using funds (e.g., from premiums or other contributions) made available through notional (i.e. owned by an insurance plan) participant HCSAs. Some elements of the platform's use of third party banking services are further defined in FIG. 2.

In an example, third party banking services are use for, among other things (1) flexibility to use multiple types of bank cards, including multi-purse health care benefits cards, for accessing an HCSA for health care payments, and (2) integration of banking services through the integration platform to enable participant-level account and transaction settlement between an insurance plan and a participant's HCSA. Various request and authorization pathways are illustrated in FIG. 2 to describe the interaction among merchant point-of-sale systems, payment networks, and bank card processing platforms, and the participant account hub.

FIG. 3 is a block diagram illustrating generally example transaction flows between a participant account hub and other aspects of the system. In an example, the Participant Account Hub integrates third party banking services and the integration platform. The Participant Account Hub provides, among other things, (1) receipt of authorized participant health care transactions (charges/debits and corrections/credits), (2) allocation of those transactions based on the terms of the participant's health insurance plan and HCSA balance(s), and (3) updates the participant's balance(s) via the bank card processing platform (i.e., updates the participant's personal HCSA) to account for insurance plan terms such as deductibles, co-insurance obligations, and maximum out-of-pocket limits, among other considerations. In an example, the participant account hub exchanges information with the plan control hub to receive information about a participant's (or other's) plan, and exchanges information with a contribution portal.

FIG. 4 is a block diagram illustrating generally example transaction flows in a contribution portal. In an example, an HCSA can be funded by contributions from multiple sources, including, among others, a portion of premiums paid by either employers or individual participants, allowances provided by employers using self-insured plans, incentive payments from participation in health and wellness programs, or participant payments if they use their HSCA line of credit. In an example, contributions can be allocated to one or more accounts controlled by the HCSA. For example, particular contributions can be applied to line-of-credit interest or principal balances, or contributions can be applied to the general cash-like account balance or to an incentive account balance.

FIG. 5 is a block diagram illustrating generally an example of a plan control hub. In an example, the Plans Control Hub can implement and define new health care plans for groups (either fully insured or self insured) and participants, update plans as changes are rolled out for new enrollment periods, or create a consistent point of control for the distribution or use of all parameters and options used across the product integration platform. That is, in some examples, the Plans Control Hub serves as a repository of plan information that corresponds to a particular participant or group of participants.

FIGS. 6, 7, and 8 are block diagrams illustrating generally examples of rules-based transaction processing, and FIG. 9 is a table illustrating generally several examples of account transactions. The examples of FIGS. 6, 7, and 8 illustrate generally examples of rules-based transaction processing hierarchies that can be used by the Participant Account Hub, and examples of how the rules are used to process participant health care transactions. For example, FIG. 6 shows how debit and credit transactions can be distinguished and processed. If a debit transaction is identified, the rules provided in FIG. 7, among others, can be applied to the transaction. If a credit transaction is identified, the rules provided in FIG. 8 can be applied to the transaction. FIG. 9 illustrates generally several examples that include Participant Account Hub transactions. In Example 1, for instance, the starting balances of the HCSA are provided in the first row. Example 1 includes an approved debit transaction for $1,500, e.g., to a provider (e.g., as initiated by the provider's point-of-sale system and communicated to the Participant Account Hub via various payment networks and bank card processing platforms). From the provider's perspective, the entire $1,500 transaction is completed and the participant's debt is fully satisfied. There are no codes or claims to process by the provider, the insurer, or the participant. To settle the transaction, $1,000 is first allocated to the provider from the participant's “Health Care Allowance” portion of the participant's HCSA. The participant's available Incentive Balance is applied next ($200), and the participant's available line-of-credit is then tapped for the balance ($300). In this example, the portion of the transaction that exceeds the available Allowance and Incentive balances is applied to the participant's deductible and added to the participant's maximum out of pocket (e.g., for the plan term).

FIG. 10 is a block diagram illustrating generally an example that includes contribution processing rules, and FIG. 11 is a table illustrating generally several examples of account contribution transactions. The examples of FIGS. 10 and 11 illustrate generally rules-based contribution processing hierarchies that can be used by the contribution portal, and include examples of how the rules are used to process typical contributions. FIG. 10 illustrates generally that contribution processing rules can include distinguishing line-of-credit payments or contributions, premium contributions, self-insured allowances, and incentive contributions, and making corresponding contributions to one or more portions of an HCSA. In an example, once a contribution transaction event is processed according to the processing rules (e.g., in a participant-specific manner, or according to a participant-specific plan), the transaction event can be applied to a participant HCSA, such as using the Participant Account Hub.

In an example, an HCSA is provided alongside a traditional health insurance plan that is configured to provide a plan participant with coverage for major medical expenses like hospitalizations, surgeries, or other medical expenses such as exceeding a particular dollar amount. That is, for some qualified events (e.g., defined by the insurer in the plan contract with the participant), the participant's HCSA would be unused, or only partially used, and a traditional health insurance plan (e.g., involving a deductible, co-insurance, or other coverage) can be applied to cover such major expenses.

### Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method comprising:
providing a notional participant account; and
processing a debit transaction using the notional participant account, processing the transaction including:
identifying a first balance in a first portion of the notional participant account and allocating first funds in an amount less than or equal to the identified first balance from the first portion of the notional participant account to satisfy all or a portion of the debit transaction;
when a balance remains in the debit transaction after allocating the first funds, identifying a second balance in one or more other portions of the notional participant account and allocating second funds in an amount less than or equal to the identified second balance from the one or more other portions of the notional participant account to satisfy all or a portion of the remaining debit transaction; and
when a balance remains in the debit transaction after allocating the first and second funds, identifying a participant line-of-credit and allocating the remainder of the debit transaction using all or a portion of the identified line of credit up to a participant line-of-credit maximum.

2. The method of claim 1, wherein the allocating the remainder of the debit transaction using all or a portion of the identified line of credit up to a participant line-of-credit maximum includes contributing a plan amount to satisfy a remaining portion of the debit transaction that exceeds the participant line-of-credit maximum.

3. The method of claim 1, wherein identifying the balance in the first account includes identifying a cash balance.

4. The method of claim 1, comprising:
allocating funds to the notional participant account, the allocating funds including:
allocating the funds to a line of credit interest amount owed; and
if the line of credit interest amount owed is exceeded by the funds, allocating the remaining funds to a line of credit principal amount owed; and
if the line of credit principal amount owed is exceeded by the funds, allocating the remaining funds to a participant same-as-cash account.

5. The method of claim 4, wherein allocating funds includes first deducting a portion of the funds for payment of a plan premium.

6. The method of claim 1, wherein the providing the notional participant account includes using a participant account layer that includes multiple notional participant accounts, the multiple notional participant accounts accessible using respective participant-specific banking cards.

7. The method of claim 1, wherein the processing the debit transaction includes using a banking card processing layer configured to receive a transaction request for a balance transfer from a participant account to a provider account.

8. The method of claim 1, comprising retrieving one or more transaction rules from a plans control hub, wherein the processing the debit transaction includes using the retrieved one or more transaction rules.

9. A processor-readable medium comprising instructions that, when executed by a processor, cause the processor to:
identify a transaction type;
determine a participant-specific plan parameter corresponding to the identified transaction type;
apply a rules-based allocation of participant or plan resources to satisfy the transaction, the rules-based allocation based on the determined participant-specific plan parameter; and
update a participant account using the rules-based allocation.

10. The processor-readable medium of claim 9, wherein the instructions cause the processor to:
receive a participant-specific plan parameter from a remote plans repository database;
wherein the instruction to determine the participant-specific plan parameter includes using the participant-specific plan parameter received from the remote database; and
wherein the instructions to apply the rules-based allocation includes using the participant-specific plan parameter received from the remote database.

11. The processor-readable medium of claim 9, wherein the instructions to apply the rules-based allocation to satisfy the transaction includes using a hierarchy of account balances.

12. The processor-readable medium of claim 11, wherein the hierarchy of notional account balances include:
an incentive balance;
a health care account balance;
a line-of-credit balance;
a deductible balance;
a co-insurance contribution; or
a participant out-of-pocket maximum.

13. The processor-readable medium of claim 9, wherein the instructions to determine the participant-specific plan parameter corresponding to the identified transaction type include instructions to retrieve the participant-specific plan parameter from a plans control hub, and wherein the instructions to apply the rules-based allocation include instructions to use the retrieved participant-specific plan parameter.

14. The processor-readable medium of claim 9, wherein the instructions to identify the transaction type include using information from a merchant point of sale system to determine whether the transaction type is a debit or credit.

15. The processor-readable medium of claim 14, comprising instructions that cause the processor to generate an alert to be provided to a plan participant, the alert including information about the transaction.

16. The processor-readable medium of claim 14, comprising instructions that cause the processor to generate an alert to be provided to a plan participant, the alert including information about a participant account balance.

17. A system for health care account processing, the system comprising:
a third party banking services layer; and
an integration platform layer, in data communication with the third party banking services layer, the integration platform layer comprising:
a plans control hub module that includes participant health care plan parameters for multiple different participant health care plans; and
a participant account hub that is configured to exchange participant account information with the third party banking services layer, using one or more transaction allocation rules received from the plans control hub, to update a participant-specific notional account.

18. The system of claim 17, wherein the integration platform layer comprises a contribution portal configured to receive information about a monetary contribution to the participant-specific notional account.

19. The system of claim 18, wherein the contribution portal is configured to receive the information about the monetary contribution using the third party banking services layer, and wherein the participant account hub is configured to apply the information about the monetary contribution to the participant-specific notional account.

20. The system of claim 17, comprising a benefits card that includes information about a participant-specific notional account, and wherein at least one of the third party banking services layer or the integration platform layer is configured to use the information from the benefits card about the participant-specific notional account to perform a participant-specific account transaction.
